(19) United States
(12) Patent Application Publication
(10) Pub. No.: US 2013/0312795 A1
(43) Pub. Date: Nov. 28, 2013

(54) APPARATUS AND METHODS FOR CLEANING MATS

(71) Applicant: Dino Anthony Camarano, Fort Myers, FL (US)

(72) Inventor: Dino Anthony Camarano, Fort Myers, FL (US)

(21) Appl. No.: 13/479,264

(22) Filed: May 23, 2012

(51) Int. Cl. B08B 3/04

(52) U.S. Cl. CPC B08B 3/04
USPC 134/115 R

(57) ABSTRACT

A mat caddy allows a person to wheel the caddy to the location of heavy rubber bar and kitchen mats to load or unload the mats into or from the caddy at the point of use of the mats. The mat caddy can be filled with water, cleanser, and/or disinfectant to allow the mats to soak, clean and disinfect. The mat caddy has a drain to allow the liquid to easily drain from the mat caddy. The mat caddy resolves the issue of having to drag heavy rubber bar and kitchen mats outside to clean them while saving time and preventing injury to employees.

### BACKGROUND OF THE INVENTION

The present invention relates to cleaning supplies and methods and more particularly, to apparatus and methods for cleaning/disinfecting heavy mats used in commercial and privately owned bars and restaurants.

Mats used in bars and restaurants are often very heavy and require routine cleaning and disinfecting. Typically, employees need to drag these heavy rubber bar and kitchen mats outside to rinse them off and/or disinfect them. This takes considerable time and effort on the employees and could even risk injury to employees when they try to lift, move, clean and replace these heavy mats.

As can be seen, there is a need for improved methods and apparatus for cleaning and disinfecting mats.

### SUMMARY OF THE INVENTION

In one aspect of the present invention, a mat caddy comprises a tank having a plurality of walls; a door disposed as one of the plurality of the walls of the tank, the door sealingly engagable with adjacent walls, the door permitting access into the tank; a drainage basin disposed as a bottom member of the tank; a plurality of dividers disposed inside the tank, the dividers providing mat stations inside the tank; and a drain hole in the drainage basin.

In another aspect of the present invention, a mat caddy comprises a tank having a plurality of walls; a door disposed as one of the plurality of the walls of the tank, the door sealingly engagable with adjacent walls, the door permitting access into the tank; a drainage basin disposed as a bottom member of the tank; a plurality of dividers disposed inside the tank, the dividers providing mat stations inside the tank; a drain hole in the drainage basin; a frame supporting the tank; a plurality of casters supporting the frame on a surface; a drain pipe extending from the drain hole; and a valve disposed to control fluid flow through the drain pipe.

In a further aspect of the present invention, a method for cleaning mats comprises moving a mat caddy to a dirty mat, the mat caddy having a plurality of casters supporting a frame, the frame supporting a tank having a plurality of walls, a door disposed as one of the plurality of the walls of the tank, the door sealingly engagable with adjacent walls, the door permitting access into the tank, a drainage basin disposed as a bottom member of the tank, and a plurality of dividers disposed inside the tank, the dividers providing mat stations inside the tank; opening the door of the mat caddy; inserting the dirty mat into one of the mat stations; adding water and cleaner inside the tank to cover the dirty mat with water; draining the water and cleaner, after a predetermined period of time, through a drain hole formed in the drainage basin; and removing the mat from the mat caddy.

These and other features, aspects and advantages of the present invention will become better understood with reference to the following drawings, description and claims.

### BRIEF DESCRIPTION OF THE DRAWINGS

FIG. 1 is a top view of a mat caddy according to an exemplary embodiment of the present invention;

FIG. 2 is a front view of the mat caddy of FIG. 1;

FIG. 3 is a rear view of the mat caddy of FIG. 1;

FIG. 4 is a right side view of the mat caddy of FIG. 1;

FIG. 5 is a top view of a drainage basin of the mat caddy of FIG. 1;

FIG. 6 is a cross-sectional view taken along line 6-6 of FIG. 1;

FIG. 7 is a top view of a support frame for the mat caddy of FIG. 1;

FIG. 8 is a detailed view of a door jamb at a pull side of the door of the mat caddy of FIG. 1;

FIG. 9 is a detailed view of a door jamb at a hinge side of the door of the mat caddy of FIG. 1;

FIG. 10 is a detailed view of a door threshold of the mat caddy of FIG. 1;

FIG. 11 is a detailed view of a door of the mat caddy of FIG. 1; and

FIG. 12 is a detailed view of a side wall portion of the mat caddy of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a mat caddy that allows a person to wheel the caddy to the location of heavy rubber bar and kitchen mats to load or unload the mats into or from the caddy at the point of use of the mats. The mat caddy can be filled with water, cleanser, and/or disinfectant to allow the mats to soak, clean and disinfect. The mat caddy has a drain to allow the liquid to easily drain from the mat caddy. The mat caddy resolves the issue of having to drag heavy rubber bar and kitchen mats outside to clean them while saving time and preventing injury to employees.

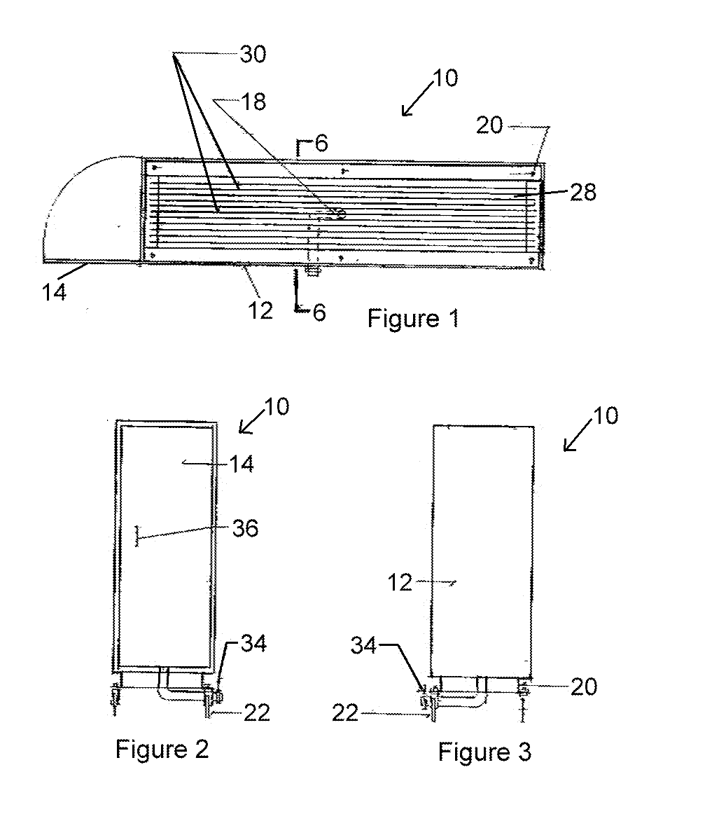

Referring now to FIGS. 1 through 7, a mat caddy 10 is configured as a four sided, water-tight tank 12 having a door 14 on a front side thereof. The door may include one or more door pulls 36 attached to the exterior of the door 14. The tank 12 includes a drainage basin 16 having at least one drain hole 18 formed therethrough. The drainage basin 16 may be carried by a frame 20. The frame 20 may include a plurality of casters 22 to allow the mat caddy 10 to be easily transported over a surface. In an exemplary embodiment, the tank 12 may be about 18 inches wide and about 72 inches long, although other lengths and widths are contemplated within the scope of the present invention. The tank 12 may be made of a reinforced plastic material, although other materials may be used, as appropriate for the intended use.

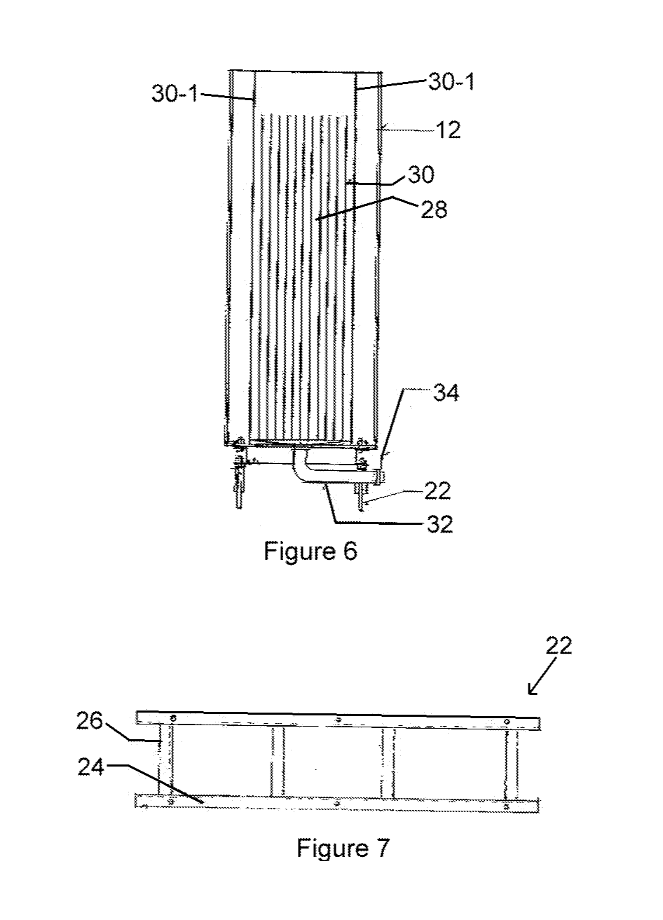

The drainage basin 16 may be sloped to a single drain hole 18, as shown in FIG. 6. The drainage basin 16 may slope from side to side and also from end to end, toward the drain hole 18. A drain pipe 32 may connect to the drain hole 18. The drain pipe 32 may extend to a side of the mat caddy 10. A drain valve 34 may be disposed on the drain pipe 32. The drain valve 34 may allow a user to easily control the mat caddy 10 to either hold water or drain water. The end of the drain pipe 32 may include a variety of fittings or hoses (not shown), as may be desired by an end user, to direct drainage from the mat caddy 10 into an appropriate area. In some embodiments, the drain pipe 32 may simply drain out the water directly out of the drain pipe 32, depending on the needs of the user.

Typically, at least four casters 22 are disposed at or near each corner of the frame 20. Six or more casters 22 may be disposed along the frame 20 to provide additional support for the mat caddy 10. The casters 22 may be, for example, casters having four-inch wheels.

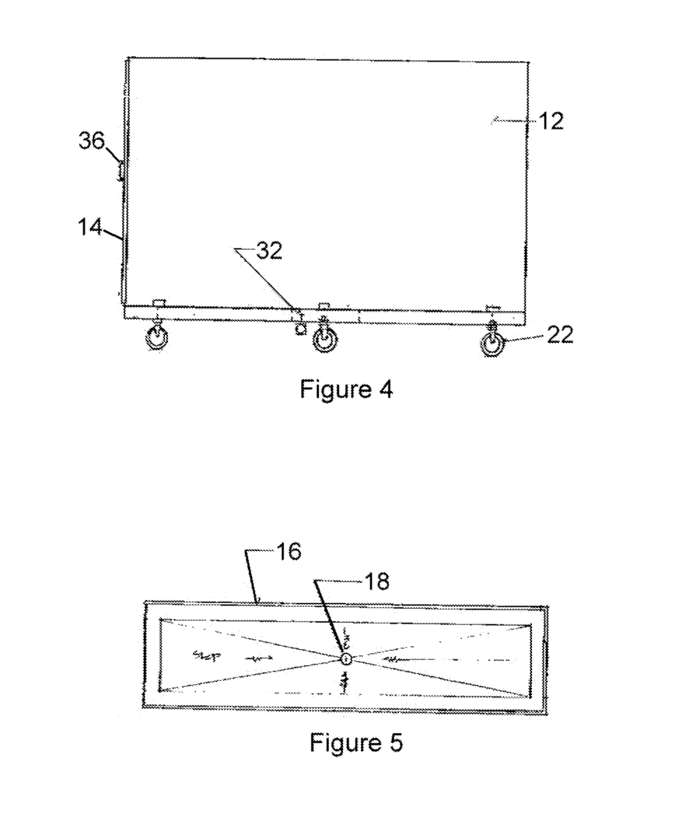

The frame 20 may include side members 24 running along each side of the mat caddy 10. A plurality of cross members 26 may interconnect the side members 24. Typically, four cross members 26 may be used, as shown in FIG. 4. In an exemplary embodiment, the frame 20 may be made of 2″×2″×2″×⅛″ steel C-channel, however, other suitable sizes may be contemplated within the scope of the present invention. In an exemplary embodiment, the frame 20 may be about 16 inches wide and about 72 inches long, however, other lengths and widths are contemplated within the scope of the present invention.

A plurality of mat stations 28 may be disposed inside the mat caddy 10. The mat stations 28 may be formed by disposing a plurality of dividers 30 inside the mat caddy 10. Typically, the dividers 30 may be disposed about 1 inch apart, however, the dividers 30 may be positioned closer or farther apart, depending on, for example, the thickness of the mats to be positioned in the mat stations 28. End dividers 30-1 may have a height larger than those dividers 30 in between the end dividers 30-1. This may allow water to flow between the various mat stations 28.

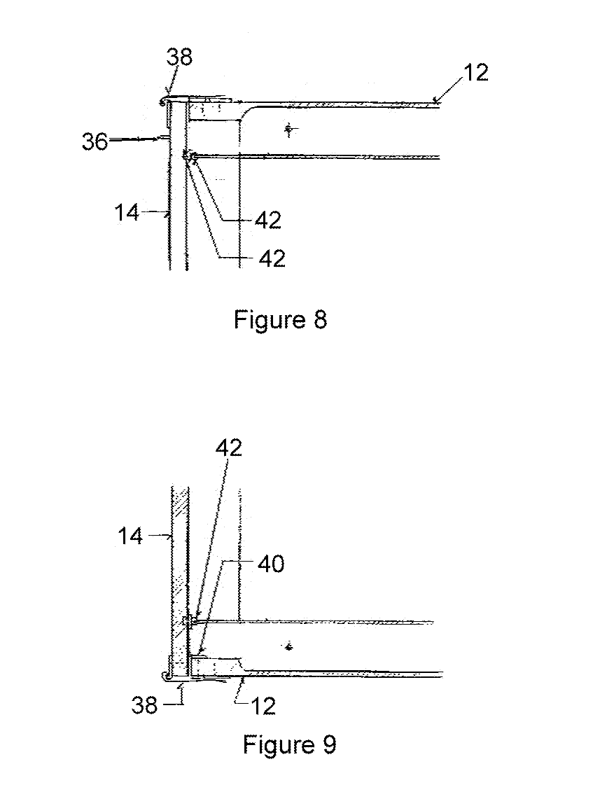

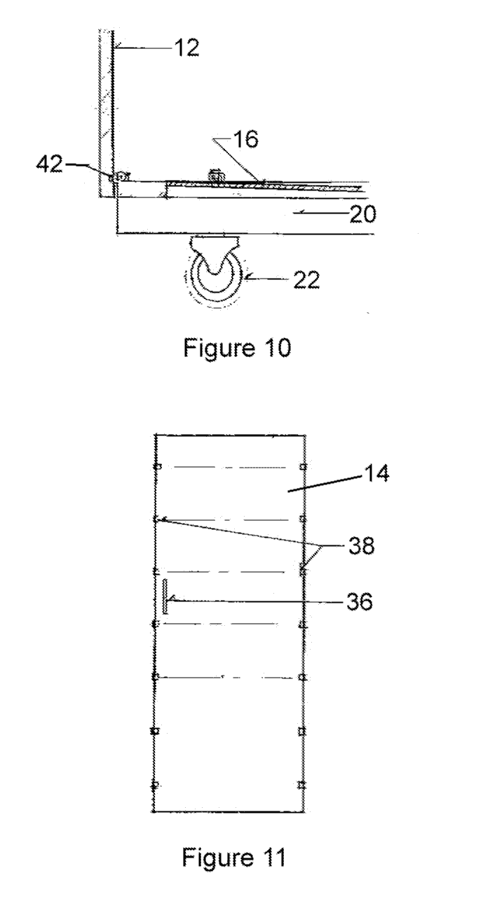

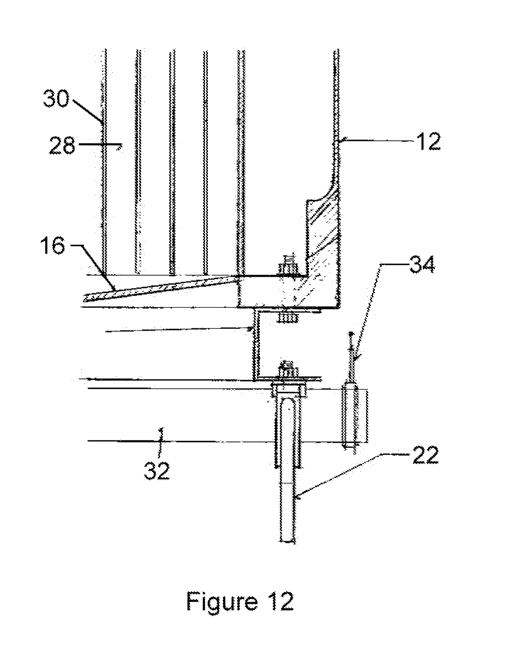

Referring now to FIGS. 8 through 11, the door 14 may be attached to the front of the mat caddy 10 with a plurality of locks 38 and hinges 40. Cabined locks 38 may be applied along each side of the door 14, for example, at six-inch intervals, to ensure the door seals against the sides of the tank 12. The hinges 40 may be disposed along one side of the door 14 to allow the door 14 to swing open and closed. A plurality of seals 42 may be disposed at the threshold, hinge side and pull side of the door 14. The seals 42 may be made from rubber, such as ethylene propylene diene monomer (EDPM) rubber.

A motorized agitator (not shown) or some other fluid circulator, could be added to the mat caddy 10 to provide for improved cleaning efficiency. The agitator may, for example, circulate fluid from the drain pipe 32 and re-introduce this fluid into the tank 12.

It should be understood, of course, that the foregoing relates to exemplary embodiments of the invention and that modifications may be made without departing from the spirit and scope of the invention as set forth in the following claims.

What is claimed is:

1. A mat caddy comprising:
a tank having a plurality of walls;
a door disposed as one of the plurality of the walls of the tank, the door sealingly engagable with adjacent walls, the door permitting access into the tank;
a drainage basin disposed as a bottom member of the tank;
a plurality of dividers disposed inside the tank, the dividers providing mat stations inside the tank; and
a drain hole in the drainage basin.

2. The mat caddy of claim 1, further comprising a frame supporting the tank.

3. The mat caddy of claim 2, further comprising a plurality of casters supporting the frame on a surface.

4. The mat caddy of claim 1, wherein the drainage basin slopes toward the drain hole.

5. The mat caddy of claim 1, further comprising:
a drain pipe extending from the drain hole; and
a valve disposed to control fluid flow through the drain pipe.

6. The mat caddy of claim 1, further comprising a plurality of seals and locks to retain the door in a sealing engagement with the adjacent walls of the tank.

7. A mat caddy comprising:
a tank having a plurality of walls;
a door disposed as one of the plurality of the walls of the tank, the door sealingly engagable with adjacent walls, the door permitting access into the tank;
a drainage basin disposed as a bottom member of the tank;
a plurality of dividers disposed inside the tank, the dividers providing mat stations inside the tank;
a drain hole in the drainage basin;
a frame supporting the tank;
a plurality of casters supporting the frame on a surface;
a drain pipe extending from the drain hole; and
a valve disposed to control fluid flow through the drain pipe.

8. The mat caddy of claim 7, wherein the drainage basin slopes toward the drain hole, wherein the drain hole is disposed in a central location in the drainage basis.

9. A method for cleaning mats comprising:
moving a mat caddy to a dirty mat, the mat caddy having a plurality of casters supporting a frame, the frame supporting a tank having a plurality of walls, a door disposed as one of the plurality of the walls of the tank, the door sealingly engagable with adjacent walls, the door permitting access into the tank, a drainage basin disposed as a bottom member of the tank, and a plurality of dividers disposed inside the tank, the dividers providing mat stations inside the tank;
opening the door of the mat caddy;
inserting the dirty mat into one of the mat stations;
adding water and cleaner inside the tank to cover the dirty mat with water;
draining the water and cleaner, after a predetermined period of time, through a drain hole formed in the drainage basin; and
removing the mat from the mat caddy.

10. The method of claim 9, further comprising closing the door and locking a plurality of locks on the door to seal the door to adjacent walls of the tank.
